(19) United States
(12) Patent Application Publication
(10) Pub. No.: US 2026/0054673 A1
(43) Pub. Date: Feb. 26, 2026

(54) DISASSEMBLY SYSTEM

(71) Applicant: AUDI AG, lngolstadt (DE)

(72) Inventors: Cristina SANZ, lngolstadt (DE); Mehmet UZUNHAN, lngolstadt (DE); Andreas GENNRICH, 85119 (DE); Ralph GUNI, lngolstadt (DE); Franz-Xaver PERRAS, Breitenbrunn (DE)

(21) Appl. No.: 19/245,533

(22) Filed: Jun. 23, 2025

(30) Foreign Application Priority Data
Aug. 23, 2024 (DE) 102024124175.6

(51) Int. Cl. B60R 19/24; B60R 19/02

(52) U.S. Cl. CPC B60R 19/24; B60R 19/023

(57) ABSTRACT

A disassembly system for a crash management system for a vehicle, the crash management system has two deformation elements and a cross member. The deformation elements are connected to one another via the cross member and are to be arranged on one side of the vehicle. A tool of the disassembly system for disassembling the crash management system is to be arranged between the two deformation elements, the tool is designed to set a disassembly distance between the deformation elements when disassembling the crash management system from the vehicle.

### FIELD

The invention relates to a disassembly system and a method for disassembling a crash management system.

### BACKGROUND

DE 10 2005 051 764 A1 describes a crash box for attachment to a longitudinal member of a motor vehicle.

A motor vehicle body with a front longitudinal member is known from DE 10 2013 222 911 A1.

### SUMMARY

Against this background, an object was to remove a crash management system from a vehicle in an appropriate manner.

The disassembly system according to the invention is designed for a crash management system for a vehicle. The crash management system has two deformation elements or crash boxes and a cross member, wherein the deformation elements are connected to one another via the cross member and are to be arranged, can be arranged or are arranged, and are usually to be fastened, can be fastened or are fastened, on one side of the vehicle, e.g. on a body. The tool must be positioned between the two deformation elements to disassemble the crash management system. The tool is designed to set, maintain and/or keep a disassembly distance between the deformation elements when disassembling and removing the crash management system from the vehicle.

In an embodiment, the usually elongated tool has at least two elongated transverse modules which are to be positioned or can be positioned relative to each other in the longitudinal direction, wherein a length of the tool is to be variably adjusted or can be variably adjusted.

In addition, the transverse modules are to be fixed or can be fixed to one another via at least one fixing element, wherein and/or whereby a certain length of the tool between the two deformation elements is or can be adjusted. The transverse modules must be temporarily and removably fastened to each other using the fixing element.

It is possible for the tool to have at least one cylindrical transverse module, for example a rod or a tube, and at least one thread, for example an external thread on an outer wall of the rod, wherein the thread can also be designed and/or referred to as a cylindrical transverse module.

It is possible for the tool to have an outer tube with the internal thread as the primary thread, as the primary cylindrical transverse module, and an inner tube or an inner rod with the external thread as the secondary cylindrical transverse module, which can be arranged, are to be arranged or are arranged coaxially to one another. Both transverse modules can be connected, are to be connected or are connected to each other via the threads, when the threads engage with each other, e.g. are screwed together. In addition, the transverse modules can be positioned relative to each other by rotating them relative to each other, e.g. they are moved or can be moved and/or are telescoped or can be telescoped. By relative positioning, moving, rotating and/or telescoping of the transverse modules, the respectively set length of the tool is to be or can be fixed using a fixing nut as a fixing element.

It is also possible for each deformation element to have a receptacle, e.g. an opening and/or recess. In each case, a receptacle is designed to receive one end of the tool or one end of one of the transverse modules, wherein one respective end of the tool or of a transverse module is to be or is arranged in a receptacle.

The method according to the invention is provided for disassembling and/or removing a crash management system from a vehicle, wherein the crash management system has two deformation elements and a cross member as components, wherein the deformation elements are connected to one another via the cross member and are also arranged, usually fastened, on one side of the vehicle. To disassemble the crash management system, a tool is placed between the two deformation elements, wherein the tool is used to set a disassembling distance between the two deformation elements when disassembling the crash management system from the vehicle.

It is possible that an embodiment of the method is carried out with an embodiment of the disassembly system presented here.

In an embodiment of the method, a tool consisting of two elongated transverse modules is used, which are positioned relative to each other, e.g. by moving, rotating and/or telescoping them. In this case, an original length is initially set for the tool which is less than the distance between the two deformation elements. Then the tool is arranged parallel to the cross member between the deformation elements. In addition, a length of the tool between the deformation elements is increased until one respective end of the tool comes into contact with a deformation element, wherein in one embodiment one respective end is arranged and/or received in a receptacle of a deformation element. Furthermore, the tool is tensioned and/or clamped between the deformation elements, wherein the two deformation elements are spaced apart from each other by the tool located between them, which is tensioned and/or clamped, for example, or are kept at the disassembly distance as a minimum distance. The tool is set to a length that corresponds to the disassembly distance.

It is possible for the tool to have two transverse modules, for example an outer tube and an inner tube or an inner rod, each transverse module having a thread, these two threads being designed to fit and/or complement each other. The inner tube or inner rod can have an external thread on an outer wall and the outer tube can have an internal thread on an inner wall. The external thread on the inner tube or on the inner rod is screwed into the internal thread on the outer tube. Furthermore, the transverse modules are rotated coaxially relative to each other either clockwise or counterclockwise, wherein the length of the tool is varied or changed. In one embodiment, the external thread of the inner tube is turned, e.g. screwed, into the internal thread of the outer tube to reduce or shorten the length of the tool, or turned, e.g. unscrewed, out of the internal thread to increase the length.

It is intended that the deformation elements and thus also the cross member connecting them can be separated and/or removed from the vehicle when or as soon as the tool is arranged between them.

It is possible that the crash management system is or was originally fastened, using fastening elements, usually bolts, e.g. welding bolts, screws, e.g. welding screws and/or nuts, e.g. weld nuts, to the body and/or to a structural component of the vehicle. The process for disassembling or for the disassembly of the crash management system is usually carried out after a crash event or after an accident involving the vehicle, if or after at least one component of the crash system and/or a component of the vehicle on the side where the crash system is fastened, has been deformed due to the crash event.

The tool as a component of the disassembly system has in an embodiment at least the rod and the thread and supports the disassembly of the crash management system. The tool is used to hold and/or push the crash boxes of the crash management system outwards before and/or during disassembly so that disassembly can be carried out without problems. This allows the crash management system to be easily disassembled without damaging the fastening elements with which the crash management system is or was fastened to the vehicle.

The crash management system is connected to the body in the back or rear of the vehicle or in the front section or front of the vehicle via welding bolts and/or welding nuts as fastening elements. Depending on the deformation of the crash management system after a crash or accident, stresses in the transverse direction of the crash management system can be considerable. These stresses are compensated by inserting the tool between the deformation elements, when the tool pushes the two deformation elements apart and thereby spaces them apart. The crash management system can now be easily unscrewed. It is therefore not necessary to cut the cross member in half to disassemble it.

It is apparent that the above-mentioned features and the features still to be explained hereinafter can be applied not only in the particular specified combination but rather also in other combinations or alone, without leaving the scope of the present invention.

### BRIEF DESCRIPTION OF THE FIGURES

The invention is illustrated schematically in the drawing in the context of embodiments, and will be described schematically and in detail with reference to the drawing.

FIG. 1a shows a schematic representation of a vehicle with a crash management system from a first perspective.

FIG. 1b shows a schematic representation of the vehicle and the crash management system from FIG. 1a from a second perspective and a first embodiment of the disassembly system according to the invention for carrying out a first embodiment of the method according to the invention.

FIG. 2 shows a schematic representation of a second embodiment of the disassembly system according to the invention for carrying out a second embodiment of the method according to the invention.

### DETAILED DESCRIPTION

The figures will be described coherently and comprehensively. Identical reference signs are assigned to the same components.

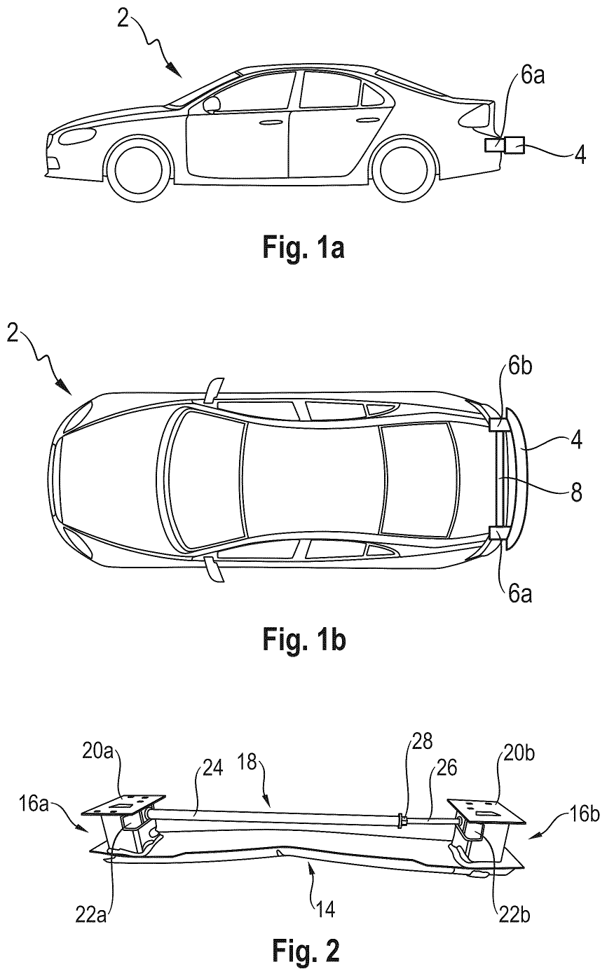

FIG. 1a shows vehicle 2, here a motor vehicle, from the side. FIG. 1b shows vehicle 2 from above.

The crash management system comprises as components a cross member 4 and two deformation elements 6a, 6b, wherein the deformation elements 6a, 6b are offset from one another on the cross member 4 along its longitudinal direction. The crash management system is arranged when mounted on a rear side or at the rear of the vehicle 2, as shown here, or alternatively on a front side or at the front of the vehicle 2, wherein a deformation element 6a, 6b is connected to the vehicle 2 and/or fastened to the vehicle 2, usually via fastening elements. During assembly, the deformation elements 6a, 6b and the cross member 4 have an original shape, wherein the cross member 4 is here convexly curved relative to the vehicle 2.

It is possible that at least one component of the crash management system will be deformed after an accident involving vehicle 2, which is why the crash management system must be removed from vehicle 2 after the accident.

For this purpose, the first embodiment of the method according to the invention for disassembling and/or removing the crash management system from the vehicle 2 is carried out with the first embodiment of the disassembly system according to the invention.

The first embodiment of the disassembly system according to the invention comprises here a tool 8 which is arranged between the two deformation elements 6a, 6b for disassembling the crash management system. In each case one end of the rod- and/or bar-shaped tool 8 comes into contact with a deformation element 6a, 6b, wherein a disassembling distance is set between the deformation elements 6a, 6b using the tool 8 before or for disassembling the crash management system from the vehicle 2, wherein the deformation elements 6a, 6b are pressed apart and/or spaced apart by the tool 8 during disassembling and thus facilitate the removal, e.g. unscrewing of the crash management system from vehicle 2.

FIG. 2 shows here another crash management system, which also has a cross member 14 on which two deformation elements 16a, 16b are arranged. In this case, a fastening plate 20a, 20b is arranged on each deformation element 16a, 16b as a fastening element, via which plate each deformation element 16a, 16b and thus also the crash management system is to be fastened or is fastened to the vehicle, for example via bolts as additional fastening elements.

The second embodiment of the disassembly system according to the invention comprises a tool 18 which comprises two tubes as components, namely an outer tube 24, on the inner wall of which an internal thread is arranged, and an inner tube 26, on the outer wall of which an external thread is arranged, as well as a fixing nut 28 as a fixing element. In addition, the disassembly system has a receptacle 22a, 22b in each of the two deformation elements 6a, 6b, which is here formed into a respective deformation element 6a, 6b.

It is intended that in the event of an accident involving a vehicle to which the crash management system is fastened, the cross member 14 will be deformed, which can also be seen in FIG. 2. To remove the crash management system, the second embodiment of the method according to the invention is carried out.

In the method, it is possible for the external thread of the inner tube 26 to be screwed and/or turned into the internal thread of the outer tube 24, wherein the outer tube 24 and the inner tube 26 are connected via their two threads. Depending on the direction of rotation of the outer tube 24 relative to the inner tube 26, a length of the tool 18 can be changed, i.e. increased or decreased.

It is provided that a length is set for the tool 18 by rotating the two tubes relative to each other, which length is less than a distance between the two receptacles 22a, 22b of the deformation elements 16a, 16b still fastened to the vehicle. Then, one end of the tool 18 or of a respective tube is arranged in a respective receptacle 22a, 22b. Thereafter, the length of the tool 18 is increased by rotating the tubes relative to each other until one end of each tube comes into contact with a deformation element 16a, 16b, here in a respective receptacle 22a, 22b, wherein both ends of the tool 18 also come into contact with the deformation elements 16a, 16b or their receptacles 22a, 22b. The tool 18 is clamped and/or pressed between the two deformation elements 16a, 16b. It is possible for the tool 18 to push the two deformation elements 16a, 16b apart or away from each other, wherein the now deformed cross member 14 is relieved of load parallel to the tool 18, wherein any stresses in the cross member 14 are compensated. The crash management system can then be removed and/or disassembled from the vehicle using the disassembly system that supports the crash management system while carrying out the disassembling.

### LIST OF REFERENCE NUMERALS

2 vehicle
4 cross member
6a, 6b deformation element
8 tool
14 cross member
16a, 16b deformation element
18 tool
20a, 20b fastening plate
22a, 22b receptacle
24 outer tube
26 inner tube
28 fixing nut

1. A disassembly system for a crash management system for a vehicle, comprising: two deformation elements and a cross member, wherein the deformation elements are connected to one another via the cross member and are to be arranged on one side of the vehicle, wherein a tool of the disassembly system for disassembling the crash management system is to be arranged between the two deformation elements, wherein the tool is designed to set a disassembly distance between the deformation elements when disassembling the crash management system from the vehicle.

2. The disassembly system according to claim 1, wherein the tool comprises at least two elongate transverse modules which are to be positioned longitudinally relative to one another.

3. The disassembly system according to claim 2, which has at least one fixing element for fixing the transverse modules.

4. The disassembly system according to claim 2, wherein the tool has at least one cylindrical transverse module with at least one thread.

5. The disassembly system according to claim 4, wherein the tool has as transverse modules an outer tube with a thread designed as an inner tube and an inner tube with a thread designed as an outer tube, wherein the transverse modules are to be arranged coaxially to one another, wherein the transverse modules are to be connected to one another via the threads and are to be positioned relative to one another by relative rotation of the threads to one another.

6. The disassembly system according to claim 1, wherein each deformation element has a receptacle, wherein each receptacle is designed to receive one end of the tool.

7. A method for disassembling a crash management system from a vehicle, wherein the crash management system has two deformation elements and a cross member, wherein the deformation elements are connected to one another via the cross member and are to be arranged on one side of the vehicle, wherein a tool for disassembling the crash management system is arranged between the two deformation elements, wherein by using the tool a disassembly distance between the deformation elements is set when disassembling the crash management system from the vehicle.

8. The method according to claim 7, in which a tool formed from two elongate transverse modules is used, wherein the transverse modules are positioned relative to one another, wherein an original length is initially set for the tool which is less than a distance between the two deformation elements, wherein the tool is arranged between the deformation elements, wherein a length of the tool between the deformation elements is increased, wherein the tool is clamped between the deformation elements.

9. The method according to claim 8, for a tool which has two transverse modules, each with a thread, wherein the transverse modules are connected to one another via the threads, wherein the transverse modules are rotated coaxially relative to one another via the threads, wherein a length of the tool is changed.

10. The method according to claim 7, wherein the deformation elements are separated from the vehicle when the tool is arranged between them.

11. The disassembly system according to claim 3, wherein the tool has at least one cylindrical transverse module with at least one thread.

12. The disassembly system according to claim 2, wherein each deformation element has a receptacle, wherein each receptacle is designed to receive one end of the tool.

13. The disassembly system according to claim 3, wherein each deformation element has a receptacle, wherein each receptacle is designed to receive one end of the tool.

14. The disassembly system according to claim 4, wherein each deformation element has a receptacle, wherein each receptacle is designed to receive one end of the tool.

15. The disassembly system according to claim 5, wherein each deformation element has a receptacle, wherein each receptacle is designed to receive one end of the tool.

16. The method according to claim 8, wherein the deformation elements are separated from the vehicle when the tool is arranged between them.

17. The method according to claim 9, wherein the deformation elements are separated from the vehicle when the tool is arranged between them.
